(19) United States
(12) Patent Application Publication
(10) Pub. No.: US 2005/0069778 A1
(43) Pub. Date: Mar. 31, 2005

(54) Structure comprising a modified fluoropolymer and electrode based on this structure

(76) Inventors: Anthony Bonnet, Beaumont Le Roger (FR); Barbara Ramfel, Longpont Sur Orge (FR); Benoit Barriere, Le Tilleul Othon (FR); Thierry Pascal, Charly (FR)

Correspondence Address: Thomas F. Roland, Esq.;Atofina Chemicals, Inc., 2000 Market St., Philadelphia, PA, 19103, US

(21) Appl. No.: 10/900,817

(22) Filed: Jul. 28, 2004

(30) Foreign Application Priority Data
Jul. 29, 2003 (FR) 03.09298

(51) Int. Cl. H01M 2/16; B32B 15/08

(52) U.S. Cl. 429/246; 428/461

(57) ABSTRACT

The present invention relates to a structure comprising, in succession: a metal layer L1, optionally a fluorinated primer L2, which is a blend comprising, by weight, 1 to 100% of at least one modified fluoropolymer per 0 to 99% of fluoropolymer, respectively, and a layer of a fluoropolymer L3; such that, if the primer layer L2 is absent, the fluoropolymer L3 is a blend comprising, by weight, 1 to 100% of at least one modified fluoropolymer per 0 to 99% of fluoropolymer, respectively; the said modified fluoropolymer being chosen from: fluoropolymers grafted with an unsaturated monomer, the grafting being carried out in the absence of oxygen by irradiation of the unsaturated monomer and of the fluoropolymer that are melt-blended beforehand, and fluoropolymers irradiated in the presence of oxygen (also referred to as oxidized fluoropolymers). The structure is useful as a positive electrode for a lithium-ion battery.

This application claims benefit under U.S.C. §119(a) of French National Application Number 03.09298, filed Jul. 29, 2003.

### FIELD OF THE INVENTION

The present invention relates to a structure comprising a modified fluoropolymer and an electrode based on this structure. More precisely, the structure comprises, in succession, a layer of a metal, optionally a modified fluorinated primer and a layer of an optionally modified fluoropolymer, the said structure being such that the fluoropolymer of at least one of the layers is a modified fluoropolymer. That is to say that, if there is no primer layer, then the fluoropolymer layer is necessarily made of a modified fluoropolymer. The fluoropolymer layer may be replaced with a fluoropolymer highly filled with carbon and/or with oxides; thus, it is an electroactive layer, and the fluoropolymer is in this case termed a “tie”—it ensures cohesion of this electroactive layer. This structure, comprising, in succession, the layer of a metal, optionally the fluorinated primer and this electroactive layer, constitutes an electrode of a lithium-ion battery.

### BACKGROUND OF THE INVENTION

In the production of lithium-ion batteries, the electroactive layer containing either mixed oxide fillers or carbon and/or graphite fillers, together with other ingredients for adjusting the electrical performance characteristics, is in general produced by dispersing the fillers in a solvent in the presence of a fluorinated polymeric tie. The dispersion thus

The metal collectors used are in general copper foils or meshes in the case of the negative electrode and aluminium foils or meshes in the case of the positive electrode. The polymeric tie ensures cohesion of the electroactive layer and adhesion to the metal collector. This cohesion and this adhesion are necessary in order for batteries to be produced properly.

Poor cohesion of the layer does not, for example, allow the electrodes to be wound or stacked within the multilayer structure of the battery without detrimental disintegration of the electroactive material. This major drawback also occurs when there is insufficient adhesion to the collector.

The performance characteristics of the battery depend closely on the properties of the tie. A good tie makes it possible to produce layers that are sufficiently filled with electroactive ingredients relative to the amount of tie necessary and thus makes it possible to have a high specific capacitance. The tie must also be stable vis-à-vis oxidation-reduction reactions during charge/discharge cycles and must also be insensitive to the electrolyte present in the battery. This electrolyte typically contains solvents of the carbonate type, such as propylene, ethylene or dimethylethyl carbonate, and a lithium salt, such as LiPF₆ or LiBF₄.

PVDF or VF2 copolymers are materials that possess the characteristics for them to be used as lithium battery ties.

Patent Application WO 97/27260 discloses a structure comprising, in succession, (i) a fluoropolymer, (ii) an adhesive consisting of a blend of two polymers chosen from PVDF homopolymer, an acrylic polymer and a copolymer based on VF2 (vinylidene fluoride, sometimes also denoted by VDF) and (iii) a metal layer. It also discloses lithium-ion battery electrodes consisting of an electroactive layer, the tie of which is of composition (ii), deposited on a copper or aluminium foil.

Patent Application WO 97/32347 discloses lithium-ion battery electrodes consisting of an electroactive layer whose tie is a fluoropolymer grafted with an acrylic polymer, the said electroactive layer being deposited on a copper or aluminium foil.

Patent EP 1 054 023 discloses a process for the chemical modification of a fluoropolymer, consisting in carry out partial dehydrofluorination followed by bringing it into contact with an oxidizing agent, especially hydrogen peroxide or a hypochlorite. The resulting fluoropolymer has very high adhesion properties, especially adhesion to metal or polymeric substrates. This fluoropolymer is a tie in the manufacture of lithium-ion battery electrodes.

Patent EP 1 138 698 discloses a structure comprising, in succession, a layer of a metal L1, a fluorinated primer L2 and a layer of a fluorinated polymer L3, in which structure the fluorinated primer L2 comes from a fluoropolymer chemically modified by partial dehydrofluorination followed by oxidation. According to one particular embodiment, this structure is an electrode of a lithium-ion battery in which the metal L1 is the collector and the fluoropolymer L3, highly filled with carbon and/or with oxides, is the electroactive layer thereof.

Patent Application WO 02/06355 discloses blends of a fluoropolymer with a fluoropolymer chemically modified by partial dehydrofluorination followed by oxidation. These blends are used in the structures disclosed in the previous two prior-art documents EP 1 054 023 and EP 1 138 698 instead of the fluoropolymer chemically modified by partial dehydrofluorination followed by oxidation.

Patent EP 0 793 286 discloses the grafting onto PVDF of mono-unsaturated monomers having a —COOH, —SO₂OH, PO(OH)₂, —COOR′, or —CONH₂ functional group. The grafting is preferably carried out by pre-irradiating the PVDF before it is brought into contact with the monomer. The PVDF and the mono-unsaturated monomer may be irradiated together, but it is not specified whether these two elements have been melt-blended. The preferred embodiment is repeated in the publication J. Power Res. 2001, 97-98, 664-666.

U.S. Pat. No. 5,415,958 discloses a copolymer of VF2 and an unsaturated monomer having carbonyl functional groups of the acid or ester type that can be used as tie for the batteries.

Whatever the adhesion of the fluoropolymers to the metals or the adhesion of the fluoropolymer-based electroactive layers in lithium-ion batteries, the prior art documents EP 1 054 023, EP 1 138 698 and WO 02/06355 disclosed satisfactory solutions. However, the technique of modifying the fluoropolymer is complicated. It has now been found that a fluoropolymer modified by irradiation can easily replace the fluoropolymer chemically modified by partial dehydrofluorination followed by oxidation, as disclosed in the prior art. This modification by irradiation may either be irradiation in the absence of oxygen of a mixture of the fluoropolymer and an unsaturated monomer, or irradiation in the presence of oxygen of the fluoropolymer alone.

### SUMMARY OF THE INVENTION

The present invention relates to a structure comprising, in succession:
a metal layer L1, optionally a fluorinated primer L2, which is a blend comprising, by weight, 1 to 100% of at least one modified fluoropolymer per 0 to 99% of fluoropolymer, respectively, and a layer of a fluoropolymer L3;
such that, if the primer layer L2 is absent, the fluoropolymer L3 is a blend comprising, by weight, 1 to 100% of at least one modified fluoropolymer per 0 to 99% of fluoropolymer, respectively;
the said modified fluoropolymer being chosen from:
   fluoropolymers grafted with an unsaturated monomer, the grafting being carried out by irradiation of the unsaturated monomer and of the fluoropolymer that are melt-blended beforehand, and
   fluoropolymers irradiated in the presence of oxygen (also referred to as oxidized fluoropolymers).

That is to say that the structure of the invention may comprise the layer L1, the modified-fluoropolymer-based primer L2 and the modified or unmodified polymer layer L3. In this structure, it is not necessary for the fluoropolymer of the layer L3 to be modified—the presence of the primer layer L2 is sufficient.

Also, the structure of the invention may contain no primer and comprise the layer L1 and the modified-fluoropolymer-based layer L3.

According to one particular embodiment, the structure of the invention is an electrode of a lithium-ion battery in which the metal L1 is the collector and the fluoropolymer L3, highly filled with carbon and/or oxides, is the electroactive layer thereof.

### DETAILED DESCRIPTION OF THE INVENTION

As regards the metal of the layer L1, mention may be made, for example, of steel, stainless steel, aluminium, copper, nickel, titanium, lead, silver, chromium and their various alloys. This layer may have any thickness. For example, it may be from a few microns to several centimetres.

As regards the fluorinated polymer, this thus denotes any polymer having in its chain at least one monomer chosen from compounds that contain a vinyl group capable of opening in order to be polymerized and that contain, directly attached to this vinyl group, at least one fluorine atom, a fluoroalkyl group or a fluoroalkoxy group.

As examples of monomers, mention may be made of vinyl fluoride; vinylidene fluoride (VDF); trifluoroethylene (VF3); chlorotrifluoroethylene (CTFE); 1,2-difluoroethylene; tetra-fluoroethylene (TFE); hexafluoropropylene (HFP); perfluoro(alkyl vinyl)ethers, such as perfluoro(methyl vinyl)ether (PMVE), perfluoro(ethyl vinyl)ether (PEVE) and perfluoro(propyl vinyl)ether (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₂OCN or CH₂OPO₃H; the product of formula CF₂═CFOCF₂CF₂SO₂F; the product of formula F(CF₂)ₙCH₂OCF═CF₂ in which n is 1, 2, 3, 4 or 5; the product of formula R₁CH₂OCF═CF₂ in which R₁ is hydrogen or F(CF₂)_{z} and z is 1, 2, 3 or 4; the product of formula R₃OCF═CH₂ in which R₃ is F(CF₂)_{z}— and z is 1, 2, 3 or 4; perfluorobutylethylene (PFBE); 3,3,3-trifluoropropene and 2-trifluoromethyl-3,3,3-trifluoro-1-propene.

The fluoropolymer may be a homopolymer or a copolymer; it may also include non-fluorinated monomers such as ethylene.

As an example, the fluoropolymer is chosen from:
homopolymers and copolymers of vinylidene fluoride (VDF) preferably containing, by weight, at least 50% VDF, the copolymer being chosen from chlorotrifluoroethylene (CTFE), hexafluoropropylene (HFP), trifluoroethylene (VF3) and tetrafluoroethylene (TFE);
homopolymers and copolymers of trifluoroethylene (VF3); and
copolymers, and especially terpolymers, combining the residues of chlorotrifluoroethylene (CTFE), tetrafluoroethylene (TFE), hexafluoropropylene (HFP) and/or ethylene units and optionally VDF and/or VF3 units.

Advantageously, the fluoropolymer is a poly(vinylidene fluoride) (PVDF) homopolymer or copolymer. Preferably, the PVDF contains, by weight, at least 50%, or preferably at least 75% and better still at least 85% VDF. The comonomer is advantageously HFP.

The fluoropolymer used in the layers L2 and L3, and which has not been modified, is chosen from the abovementioned fluoropolymers. The unmodified fluoropolymer may be a blend of unmodified fluoropolymers. The unmodified fluoropolymers of the layers L2 and L3 may be the same or different.

The modified fluoropolymers, that is to say the grafted fluoropolymers and the oxidized fluoropolymers, will now be described. They are prepared from the fluoropolymers described above.

With regard to the grafted fluoropolymers, these may be prepared by a method of grafting an unsaturated monomer onto the fluoropolymer, in which:
a) the fluoropolymer is melt-blended with the unsaturated monomer;
b) the blend obtained in a) is formed into films, sheets, granules or powder;
c) the products from step b) are subjected, in the absence of oxygen, to photon (γ) or electron (β) irradiation with a dose between 1 and 15 Mrad; and
d) the product obtained at c) is optionally treated in order to remove all or some of the unsaturated monomer that has not been grafted onto the fluoropolymer.

With regard to the unsaturated grafting monomer, mention may be made, by way of examples, of those having a carboxylic acid, acid derivative, acid chloride, isocyanate, oxazoline, epoxide, amine or hydroxide functional group.

Examples of unsaturated carboxylic acids are those having 2 to 20 carbon atoms, such as acrylic, methacrylic, maleic, fumaric and itaconic acids. The functional derivatives of these acids comprise, for example, anhydrides, ester derivatives, amide derivatives, imide derivatives and metal salts (such as alkali metal salts) of unsaturated carboxylic acids. Undecylenic acid may also be mentioned.

Unsaturated dicarboxylic acids having 4 to 10 carbon atoms and their functional derivatives, particularly their anhydrides, are particularly preferred grafting monomers.

These grafting monomers comprise, for example, maleic, fumaric, itaconic, citraconic, allylsuccinic, cyclohex-4-ene-1,2-dicarboxylic, 4-methylcyclohex-4-ene-1,2-dicarboxylic, bicyclo[2.2.1]hept-5-ene-2,3-dicarboxylic and x-methylbicyclo-[2.2.1]hept-5-ene-2,3-dicarboxylic acids and maleic, itaconic, citraconic, allylsuccinic, cyclohex-4-ene-1,2-dicarboxylic, 4-methylenecyclohex-4-ene-1,2-dicarboxylic, bicyclo-[2.2.1]hept-5-ene-2,3-dicarboxylic and x-methyl-bicyclo[2.2.1]hept-5-ene-2,2-dicarboxylic anhydrides.

Examples of other grafting monomers comprise C₁-C₈ alkyl esters or glycidyl ester derivatives of unsaturated carboxylic acids, such as methyl acrylate, methyl methacrylate, ethyl acrylate, ethyl methacrylate, butyl acrylate, butyl methacrylate, glycidyl acrylate, glycidyl methacrylate, monoethyl maleate, diethyl maleate, monomethyl fumarate, dimethyl fumarate, monomethyl itaconate and diethyl itaconate; amide derivatives of unsaturated carboxylic acids, such as acrylamide, methacrylamide, the monoamide of maleic acid, the diamide of maleic acid, the N-monoethylamide of maleic acid, the N,N-diethylamide of maleic acid, the N-monobutylamide of maleic acid, the N,N-dibutylamide of maleic acid, the monoamide of fumaric acid, the diamide of fumaric acid, the N-monoethylamide of fumaric acid, the N,N-diethylamide of fumaric acid, the N-monobutylamide of fumaric acid and the N,N-dibutylamide of fumaric acid; imide derivatives of unsaturated carboxylic acids, such as maleimide, N-butylmaleimide and N-phenylmaleimide; and metal salts of unsaturated carboxylic acids, such as sodium acrylate, sodium methacrylate, potassium acrylate and potassium methacrylate.

Advantageously, maleic anhydride is used.

Step a) is carried out in any blending device, such as extruders or mixers used in the thermoplastics industry.

With regard to the proportions of the fluoropolymer and of the unsaturated monomer, the proportion of fluoropolymer is advantageously, by weight, from 90 to 99.9% per 0.1 to 10% of unsaturated monomer, respectively. Preferably, the proportion of fluoropolymer is from 95 to 99.9% per 0.1 to 5% of unsaturated monomer, respectively.

After step a), it is found that the blend of the fluoropolymer and the unsaturated monomer has lost about 10 to 50% of the unsaturated monomer that had been introduced at the start of step a). This proportion depends on the volatility and the nature of the unsaturated monomer. In fact, the monomer was vented in the extruder or the blender and it was recovered from the venting circuits.

As regards step c), the products recovered after step b) are advantageously packaged in polyethylene bags, the air is expelled and the bags then sealed. As regards the method of irradiation, it is possible to use, without distinction, electron irradiation, more commonly known as β-irradiation, and photon irradiation, more commonly known as γ-irradiation. Advantageously, the dose is between 2 and 6 Mrad (or 20-60 kgray) and preferably between 3 and 5 Mrad (30-50 kGray). The irradiation time may vary in length depending on the nature of the irradiation source. Thus, it is known that the dose rate, expressed in kGray per unit time, for β-irradiation is higher than that for γ-irradiation, thereby consequently requiring shorter irradiation times for the grafting operation. The irradiation time may thus be between 1 minute and 40 hours, preferably between 1 minute and 20 hours and even more preferably between 1 minute and 15 hours.

With regard to step d), the ungrafted monomer may be removed by any means. The proportion of grafted monomer relative to the amount of monomer present at the start of step c) is between 50 and 100%. The product may be washed with solvents that are inert to the fluoropolymer and to the grafted functional groups. For example, when drafting with maleic anhydride, the product may be washed with chlorobenzene. It is also possible, more simply, to vacuum-degas the product recovered at step c), optionally while heating the product.

As regards the oxidized fluoropolymers, these may be prepared by a method of oxidizing the fluoropolymer, in which:
a) the fluoropolymer is formed into films, sheets, granules or powder;
b) the products from step a) are subjected, in the presence of oxygen, to photon (γ) or electron (β) irradiation with a dose of between 1 and 15 Mrad; and
c) the product obtained at b) is optionally treated in order to remove all or some of the by-product impurities.

As regards the irradiation and, firstly, step a), the products are advantageously packaged in polyethylene bags and the bags are not inerted. Advantageously, the fluoropolymer is in the form of powder. The bags may also include an aluminium layer in addition to the polyethylene layer. It is unnecessary to irradiate in the presence of pure oxygen—all that is required is for oxygen to be present. The irradiation may be carried out in the presence of an inert gas containing oxygen. The term “inert gas” denotes a gas that is not involved in the irradiation reaction or in the modification of the fluoropolymer by oxygen. Advantageously, the proportion of oxygen is between 1 and 20% by volume per 99 to 80% of inert gas, respectively. Advantageously, the irradiation is carried out in the presence of air. As regards the irradiation method in step b), it will be possible to use, without distinction, electron irradiation, more commonly known as β irradiation, and photon irradiation, more commonly known as γ-irradiation. Advantageously, the dose is between 2 and 12 Mrad and preferably between 2 and 8 Mrad.

As regards step c), the impurities may be removed by any means. The product may be washed with solvents inert to the oxidized fluoropolymer. It is also possible, more simply, to vacuum-degas the product recovered at step b), optionally while heating the product.

As regards the layer L2, the fluorinated primer is advantageously a blend comprising, by weight, 10 to 90% of at least one modified fluoropolymer per 90 to 10% of fluoropolymer, respectively. Preferably, this is a blend comprising, by weight, 15 to 55% of at least one modified fluoropolymer per 85 to 45% of fluoropolymer, respectively. The modified fluoropolymer of the blend may derive from the modification of a fluoropolymer that is different from the unmodified fluoropolymer of the blend. The modified fluoropolymer may be a blend of modified fluoropolymers such as, for example, a blend of two grafted fluoropolymers or of two oxidized fluoropolymers or of a grafted fluoropolymer and an oxidized fluoropolymer. It would not be outside the scope of the invention to add another polymer such as, for example, an acrylic polymer. As an example of an acrylic polymer, mention may be made of PMMA and impact modifiers of the core/shell type. However, in the case of battery-type structures, it is preferable for the primer to consist essentially of fluoropolymer. The blend constituting the primer may be prepared by means of the standard techniques used in the thermoplastics industry. Depending on the physical nature of the constituents, they may be dry-blended, then the blend is melted and spread onto L1. This dry blend may also be dissolved in a solvent, spread onto L1 and then the solvent evaporated in order to constitute a primer layer on L1. It is also possible to melt-blend the constituents and then spread the blend onto L1 (for example by coating) or else the blend is recovered in the form of powder or granules and then remelted and dissolved in a solvent, the process then continuing as above.

The lithium-ion battery layer L2 may include conducting fillers, such as carbon black, in order to increase its conductivity.

The MFI (melt flow index) of L2 is advantageously between 0.2 and 15 g/10 min (at 230° C. under a load of 5 kg) in the case of L2 deriving from PVDF homopolymer and between 0.2 and 30 g/10 min (at 230° C. under a load of 5 kg) in the case of L2 deriving from the VF2/HFP copolymer.

The thickness of the primer layer on the metal L1 may be between 1 and 10 μm and preferably 1 and 2 μm in the case of the lithium-ion battery electrodes.

As regards the layer L3, this consists of a fluoropolymer. It may be chosen from those mentioned above.

If the primer layer is absent, the layer L3 necessarily contains the modified fluoropolymer. Advantageously, this is a blend comprising, by weight, 10 to 90% of at least one modified fluoropolymer per 90 to 10% of fluoropolymer. Preferably, this is a blend comprising, by weight, 15 to 55% of at least one modified fluoropolymer per 85 to 45% of fluoropolymer, respectively. The modified fluoropolymer of the blend may derive from the modification of a fluoropolymer other than the unmodified fluoropolymer of the blend. The modified fluoropolymer may be a blend of modified fluoropolymers such as, for example, a blend of two grafted fluoropolymers or of two oxidized fluoropolymers or of a grafted fluoropolymer and an oxidized fluoropolymer.

Whether in structures with a primer L2 or without a primer, it would not be outside the scope of the invention to add another polymer such as, for example, an acrylic polymer. As an example of an acrylic polymer, mention may be made of PMMA and impact modifiers of the core/shell type. However, for battery-type structures, it is preferred that the polymer essentially consist of fluoropolymer. The blend may be prepared using the same techniques as for the primer.

The layer L3 may be deposited onto L1 or onto the primer, depending on the structure. In structures comprising L2 and L3, these two layers may be deposited simultaneously onto L1 by coextrusion coating.

The MVI (volume MFI) of L3 is advantageously between 0.5 and 25 cm³/10 min (at 230° C. under a load of 5 kg).

According to one particular embodiment of the invention, the layer of fluoropolymer L3 may be highly filled with carbon and/or with oxides—it is thus an electroactive layer; the fluoropolymer is in this case termed a tie—it ensures cohesion of this electroactive layer. The layers filled with mixed lithium oxides of the LiMₓO_{y} type (in which M is a transition metal such as Mn, Ni or Co) or filled with carbons of various types (special graphites or carbons used as lithium-ion intercalation compounds) are used for producing the positive electrodes (in the case of mixed oxide fillers) and negative electrodes (in the case of carbon fillers), respectively, in lithium-ion batteries.

Thus, the present invention also relates to:
A positive electrode for a lithium-ion battery with the above structure in which the metal L1 is preferably aluminium, the optional fluorinated primer L2 is a blend comprising, by weight, 1 to 100% of at least one modified fluoropolymer per 0 to 99% of fluoropolymer, respectively, and the layer of fluoropolymer L3 containing mixed oxide particles is the electroactive layer;
and such that, if the primer layer L2 is absent, the fluoropolymer L3 is a blend comprising, by weight, 1 to 100% of at least one modified fluoropolymer per 0 to 99% of fluoropolymer, respectively;
the said modified fluoropolymer being chosen from:
   fluoropolymers grafted with an unsaturated monomer, the grafting being carried out by irradiation of the unsaturated monomer and of the fluoropolymer that are melt-blended beforehand, and
   fluoropolymers irradiated in the presence of oxygen (also referred to as oxidized fluoropolymers).
A negative electrode for a lithium-ion battery with the above structure in which the metal L1 is preferably copper, the optional fluorinated primer L2 is a blend comprising, by weight, 1 to 100% of at least one modified fluoropolymer per 0 to 99% of fluoropolymer, respectively, and the layer of fluoropolymer L3 containing carbon particles is the electroactive layer;
and such that, if the primer layer L2 is absent, the fluoropolymer L3 is a blend comprising, by weight, 1 to 100% of at least one modified fluoropolymer per 0 to 99% of fluoropolymer, respectively;
the said modified fluoropolymer being chosen from:
   fluoropolymers grafted with an unsaturated monomer, the grafting being carried out by irradiation of the unsaturated monomer and of the fluoropolymer that are melt-blended beforehand, and
   fluoropolymers irradiated in the presence of oxygen (also referred to as oxidized fluoropolymers).

Everything that was described above regarding the fluoropolymers, the modified fluoropolymers and the proportions of the constituents is valid for the electrodes.

### EXAMPLES

In the examples, the following products were used:
KYNAR 720: PVDF homopolymer manufactured by Atofina having an MFI (melt flow index) of 1 to 2 g/10 min under a load of 10 kg at 230° C.;
KYNAR 761: PVDF homopolymer manufactured by Atofina having an MFI (melt flow index) of 2 to 4 g/10 min under a load of 12.5 kg at 230° C.;
KYNARFlex 2801: VF2-HFP PVDF copolymer (89% VF2-11% HFP) manufactured by Atofina, having an MVI (melt volume index) of 0.5 cm³/10 min under a load of 5 kg at 230° C. (and an MFI of 3-8 g/10 min under a load of 12.5 kg at 230° C.).
KYNAR MKB: this is a KYNAR 50 having an MFI of 1.6 (230° C./5 kg), treated by means of an oxidizing dehydrofluorination step using the operating method of Example 1 as taught in Application EP 1 054 023 assigned to the Applicant.

### Example 1

### Preparation of a PVDF Grafted with Maleic Anhydride

A blend of a PVDF from Atofina (reference in Table 1) and of maleic anhydride with the content given in Table 1 was prepared.

TABLE 1

| Reference | | Maleic anhydride content by |
|---|---|---|
| of the blend | PVDF grade | weight |
| 720-g-05 | KYNAR 720 | 0.5% |
| 761-g-05 | KYNAR 761 | 0.5% |
| 761-g-10 | KYNAR 761 | 1% |
| 761-g-20 | KYNAR 761 | 2% |
| 2801-g-10 | KYNARFlex 2801 | 1% |

This blend was prepared using a twin-screw extruder at 230° C. and 150 rpm, with an output of 10 kh/h. The product thus prepared was bagged in sealed aluminium bags. These bags were then irradiated by γ-irradiation 50 kGray (5 Mrad (megarad)). A grafting level of 50% was determined, this level being verified after a dissolution/precipitation step. The product PVDF-g-AM (the reference of which is given in Table 1) was then placed under vacuum overnight at 130° C. in order to remove the residual maleic anhydride and the hydrofluoric acid released during irradiation.

### Example 2

### Preparation of a Negative Electrode for a Lithium-Ion Battery

5 g of PVDF, modified or otherwise, were dissolved in 85 g of N-methyl-2-pyrrolidone (abbreviated in the text that follows to NMP, from Merck, purity >99%) with magnetic stirring at 55° C. for at least 30 minutes (up to 4 hours in the case of the grades that were difficult to dissolve). 45 g of MCMB 6-28 graphite powder, with a mean particle size of 6 μm, obtained from Osaka Gaz, were added to this solution. These powders were dispersed in the solution by magnetic stirring at room temperature for 30 minutes, and then for 3 minutes in a multiblade turbine disperser of the DISPERMAT brand and with vigorous stirring (2000 rpm). This solution was spread onto a 20-μm-thick copper foil and then a film was formed using a manual doctor blade set at 400 μm. The film was dried at 90° C. in a fan oven for 15 minutes and then vacuum-dried at 140° C. overnight. The conducting layer thus formed on the copper foil was thus composed of 10% PVDF and 90% graphite by weight. Its density or “grammage” was about 1.2 g/cm² and its thickness was 120 μm on average.

### Example 3

### Preparation of a Positive Electrode for an Li-Ion Battery

3 g of PVDF modified, or otherwise, were dissolved in 62 g of NMP with magnetic stirring at 55° C. for at least 30 minutes (up to 4 h in the case of the grades that were difficult to dissolve). 1.5 g of conducting carbon black powder of the acetylene type, obtained from Denka, and 45.5 g of LiCoO₂ powder having a mean particle size of 5 μm, obtained from Union Miniere, were added to this solution. These powders were dispersed in the solution with magnetic stirring at room temperature for 30 minutes, and then for 3 minutes in a multiblade turbine disperser of the DISPERMAT brand and with vigorous stirring (2000 rpm). This solution was spread onto a 20-μm-thick aluminium foil and then a film was formed using a manual doctor blade set at 350 μm. The film was dried at 90° C. in a fan oven for 15 minutes and then vacuum-dried at 140° C. overnight. The conducting layer thus formed on the aluminium foil was thus composed of 6% PVDF, 3% conducting carbon black and 91% LiCoO₂ by weight. Its density or “grammage” was about 1.9 g/cm² and its thickness was 120 μm on average.

### Example 4

### Determination of the Adhesion between the Conducting Layer (or Electroactive Layer) and the Metal Foil

Strips 25 mm in width and at least 10 cm in length were cut from the assembly described in Example 2 or in Example 3 and were then fixed to a rigid metal substrate via double-sided adhesive tape (TESA brand, reference #4970) of the same width on the conducting layer face. The assembly was pressed against the substrate, by simple manual pressure. The rigid metal substrate/double-sided adhesive/conducting layer/metal foil assembly is called the “peel specimen”.

The peel specimens were then installed on a DY30 tensile testing machine distributed by Adamel Lhomargy. The metal substrate was kept stationary. Failure between the conducting layer and the aluminium or copper foil was initiated either by hand or by means of a razor blade. The free part of the aluminium or copper foil was fixed to a movable jaw and then pulled at 180° with a pull rate of 100 mm/min. The instantaneous tensile force was determined by a 10 N load cell. The mean value of this force during the peeling between the metal foil and the conducting layer is called the “peel force”.

### Comparative Example 1

KYNAR 761 and KYNARFlex 2801, both sold by Atofina, and these same polymers modified as per Example 1 (with the references 761-g-05, 761-g-10, 761-g-20 and 2801-g-20) were used to form a negative electrode according to Example 2. Blends having different contents of the unmodified polymers (KYNAR 761 or KYNARFlex 2801) and the modified polymers (references 761-g-05, 761-g-10, 761-g-20 and 2801-g-20) were also used to manufacture negative electrodes according to Example 2. Finally, the PVDF homopolymer KF-1300 sold by Kureha (known to be a “standard” grade for this application) was used to form a negative electrode according to Example 2 and these were compared with the previous ones. Using the method described in Example 4, the peel force between the conducting layer and the copper foil was measured and the results are given in the following table 2:

TABLE 2

| Tie | Peel force (g/25 mm) |
|---|---|
| KYNAR 761 | 55 |
| KYNARFlex 2801 | 80 |
| 761-g-05 | 235 |
| 761-g-10 | 390 |
| 761-g-20 | 470 |
| KYNAR 761/761-g-10 (80/20) | 220 |
| KYNAR 761/761-g-10 (50/50) | 280 |
| 2801-g-10 | 560 |
| KYNARFlex 2801/2801-g-10 (80/20) | 305 |
| KF-1300 | 140 |

Thus, the modification of the PVDF homopolymer or of the PVDF-HFP copolymer by the grafting of maleic anhydride functional groups increases the adhesion as compared with the PVDF homopolymer or the corresponding PVDF-HFP copolymer. This may be explained by the polar and reactive nature of the maleic anhydride chemical group thus grafted onto the PVDF or PVDF-HFP polymer chains according to the method described in Example 1. In addition, the PVDF homopolymer, which is a tie of medium quality, such as KYNAR 761, may see its adhesion properties substantially improved by the addition of a small amount of a PVDF homopolymer chemically modified according to Example 1. This is also true for a PVDF-HFP copolymer.

### Comparative Example 2

KYNAR 761 and KYNARFlex 2801, both sold by Atofina, and these same polymers modified as per Example 1 (with the references 761-g-05, 761-g-10, 761-g-20 and 2801-g-20) were used in order to form a positive electrode according to Example 3. Blends having different contents of the unmodified polymers (KYNAR 761 or KYNARFlex 2801) and the modified polymers (references 761-g-05, 761-g-10, 761-g-20 and 2801-g-20) were also used to manufacture positive electrodes according to Example 3. Finally, the PVDF homopolymer KF-1300 sold by Kureha (known to be a “standard” grade for this application) was used to form a positive electrode according to Example 3 and these were compared with the previous ones. Using the method described in Example 4, the peel force between the conducting layer and the aluminium foil was measured and the results are given in the following table 3:

TABLE 3

| Tie | Peel force (g/25 mm) |
|---|---|
| KYNAR 761 | 25 |
| KYNARFlex 2801 | 35 |
| 761-g-05 | 90 |
| 761-g-10 | 160 |
| 761-g-20 | 200 |
| KYNAR 761/761-g-10 (80/20) | 65 |
| KYNAR 761/761-g-10 (50/50) | 90 |
| 2801-g-10 | 180 |
| KYNARFlex 2801/2801-g-10 (80/20) | 75 |
| KF-1300 | 60 |

Thus, the modification of the PVDF homopolymer or of the PVDF-HFP copolymer by the grafting of maleic anhydride functional groups increases the adhesion as compared with the PVDF homopolymer or the corresponding PVDF-HFP copolymer. This may be explained by the polar and reactive nature of the maleic anhydride chemical group thus grafted onto the PVDF or PVDF-HFP polymer chains according to the method described in Example 1. In addition, the PVDF homopolymer, which is a tie of medium quality, such as KYNAR® 761, may see its adhesion properties substantially improved by the addition of a small amount of a PVDF homopolymer chemically modified according to Example 1. This is also true for a PVDF-HFP copolymer.

### Comparative Example 3

KYNAR 761, KYNAR MKB and the 720-g-05 modified polymer were used to form a positive electrode according to Example 3. The KF-1300 PVDF sold by Kureha (known to be a “standard” grade for this application), was also used to form a positive electrode according to Example 3 and to compare them with the previous ones. The peel force between the conducting layer and the aluminium foil was able to be measured, and the results are given in the following table 4:

TABLE 4

| Tie | Peel force (g/25 mm) |
|---|---|
| KYNAR 761 | 106 |
| KYNAR MKB | 470 |
| 720-g-05 | 532 |
| KF-1300 | 470 |

It may be seen that the adhesion properties of the 720-g-05 are superior to those of the KF-1300. Thus, although the KF-1300 contains a polar functional group like the 720-g-05 grafted polymer according to the invention, the latter surprisingly has better adhesion properties.

1. Structure comprising, in succession:
a metal layer L1, optionally a fluorinated primer L2, which is a blend comprising, by weight, 1 to 100% of at least one modified fluoropolymer per 0 to 99% of fluoropolymer, respectively, and a layer of a fluoropolymer L3;
such that, if the primer layer L2 is absent, the fluoropolymer L3 is a blend comprising, by weight, 1 to 100% of at least one modified fluoropolymer per 0 to 99% of fluoropolymer, respectively;
the said modified fluoropolymer being chosen from:
fluoropolymers grafted with an unsaturated monomer, the grafting being carried out by irradiation of the unsaturated monomer and of the fluoropolymer that are melt-blended beforehand, and
fluoropolymers irradiated in the presence of oxygen (also referred to as oxidized fluoropolymers).

2. Structure according to claim 1, in which the metal L1 is chosen from steel, stainless steel, aluminium, copper, nickel, titanium, lead, silver, chromium and their various alloys.

3. Structure according to claim 1, in which the fluoropolymer used in the layers L2 and L3, and which is not modified, is chosen from poly(vinylidene fluoride) (PVDF) homopolymers or copolymers.

4. Structure according to claim 3, in which the PVDF contains at least 50% VDF by weight.

5. Structure according to claim 4, in which the PVDF contains at least 85% VDF by weight.

6. Structure according to claim 3, in which the comonomer in the PVDF is advantageously HFP.

7. Structure according claim 1, in which the grafted fluoropolymer and the oxidized fluoropolymer are prepared from poly(vinylidene fluoride) (PVDF) homopolymers or copolymers.

8. Structure according to claim 7, in which the PVDF contains at least 50% VDF by weight.

9. Structure according to claim 8, in which the PVDF contains at least 85% VDF by weight.

10. Structure according to claim 7, in which the comonomer in the PVDF is advantageously HFP.

11. Structure according to claim 1, in which the grafted fluoropolymer is prepared by a method of grafting an unsaturated monomer onto the fluoropolymer, in which:
a) the fluoropolymer is melt-blended with the unsaturated monomer;
b) the blend obtained in a) is formed into films, sheets, granules or powder;
c) the products from step b) are subjected, in the absence of air, to photon (γ) or electron (β) irradiation with a dose between 1 and 15 Mrad; and
d) the product obtained at c) is optionally treated in order to remove all or some of the unsaturated monomer that has not been grafted onto the fluoropolymer.

12. Structure according to claim 1, in which the oxidized fluoropolymer is prepared by a method of oxidizing the fluoropolymer, in which:
a) the fluoropolymer is formed into films, sheets, granules or powder;
b) the products from step a) are subjected, in the presence of oxygen, to photon (γ) or electron (β) irradiation with a dose of between 1 and 15 Mrad; and
c) the product obtained at b) is optionally treated in order to remove all or some of the by-product impurities.

13. Structure according to any one of the preceding claims, in which the fluorinated primer L2 is a blend comprising, by weight, 10 to 90% of at least one modified fluoropolymer per 90 to 10% of fluoropolymer, respectively.

14. Structure according to claim 13, in which the fluorinated primer L2 is a blend comprising, by weight, 15 to 55% of at least one modified fluoropolymer per 85 to 45% of fluoropolymer, respectively.

15. Structure according claim 1, in which the fluoropolymer of the layer L3 is a blend comprising, by weight, 10 to 90% of at least one modified fluoropolymer per 90 to 10% of fluoropolymer, respectively.

16. Structure according to claim 15, in which the fluoropolymer of the layer L3 is a blend comprising, by weight, 15 to 55% of at least one modified fluoropolymer per 85 to 45% of fluoropolymer, respectively.

17. Positive electrode for a lithium-ion battery comprising the structure of claim 1, in which the metal L1 is aluminium, the optional fluorinated primer L2 is a blend comprising, by weight, 1 to 100% of at least one modified fluoropolymer per 0 to 99% of fluoropolymer, respectively, and the layer of fluoropolymer L3 containing mixed oxide particles is the electroactive layer;
and such that, if the primer layer L2 is absent, the fluoropolymer L3 is a blend comprising, by weight, 1 to 100% of at least one modified fluoropolymer per 0 to 99% of fluoropolymer, respectively;
the said modified fluoropolymer being chosen from:
fluoropolymers grafted with an unsaturated monomer, the grafting being carried out by irradiation of the unsaturated monomer and of the fluoropolymer that are melt-blended beforehand, and
fluoropolymers irradiated in the presence of oxygen (also referred to as oxidized fluoropolymers).

18. Negative electrode for a lithium-ion battery comprising the structure of claim 1, in which the metal L1 is copper, the optional fluorinated primer L2 is a blend comprising, by weight, 1 to 100% of at least one modified fluoropolymer per 0 to 99% of fluoropolymer, respectively, and the layer of fluoropolymer L3 containing carbon particles is the electroactive layer;
and such that, if the primer layer L2 is absent, the fluoropolymer L3 is a blend comprising, by weight, 1 to 100% of at least one modified fluoropolymer per 0 to 99% of fluoropolymer, respectively;
the said modified fluoropolymer being chosen from:
fluoropolymers grafted with an unsaturated monomer, the grafting being carried out by irradiation of the unsaturated monomer and of the fluoropolymer that are melt-blended beforehand, and
fluoropolymers irradiated in the presence of oxygen (also referred to as oxidized fluoropolymers).
